(19) United States
(12) Patent Application Publication
(10) Pub. No.: US 2021/0259280 A1
(43) Pub. Date: Aug. 26, 2021

(54) ICE CREAM PRODUCT WITH CANDY FLOSS

(71) Applicant: Feride Asli Guder, Izmir (TR)

(72) Inventor: Feride Asli Guder, Izmir (TR)

(21) Appl. No.: 16/799,576

(22) Filed: Feb. 24, 2020

(51) Int. Cl. A23G 9/48; A23G 9/50; A23G 3/54; A23G 3/56

(52) U.S. Cl. CPC A23G 9/48; A23G 9/503; A23G 3/566; A23G 3/54; A23G 3/563; A23G 9/506

(57) ABSTRACT

An ice cream product arranged in such a manner that the ice cream stays on an ice cream cone, bowl, or cup even when the ice cream melts during the process of sale or while the consumer eats the ice cream. A Candy floss is placed on an ice cream cone, bowl, cup, or other receptacle so as to completely cover and flow over the lateral parts of the ice cream cone, bowl, cup, or receptacle. When the ice cream melts, the melted ice cream remains on the candy floss so as avoid contact with the consumer's hands and clothing, or any other area outside the cone, bowl, or cup.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND

### Technical Field

The Invention relates to an ice cream product, in which ice cream is arranged to ensure that the ice cream stays on an ice cream cone or bowl/cup even in the process of sale when the ice cream melts.

### The State of the Art

With the use of milk, fruit and some aromatic additives, ice cream comes out as a frosty product as a result of certain processes. Ice cream comes in different colors and flavors with the use of any kind of fruit. Ice cream is sold as packaged and unpackaged, in cones, sticks, bars or bowls.

Ice cream is desired to a higher degree in hot weather. Ice cream is offered as a product frozen at a certain temperature. Ice cream in cones, bowls/cups or sticks melts in a very short period of time based on air temperature. Hands and clothes of the consumer get dirty as a result of melting ice cream.

Ice cream stain that spread over clothes in daily life cannot be removed by simple washing, and people continue their day with stains on their clothing. Additives that are included in ice cream sometimes cannot be removed from clothes, and can ruin them.

The invention aims to prevent ice cream from spread over the clothes of the consumers by ensuring that the ice cream stays on the ice cream cone or bowl/cup even when the ice cream (on an ice cream cone, bowl, or cup) melts. This is even more important at the time the ice cream is sold so that the ice cream creates a good sales appearance.

Ice cream is often offered to consumers unpackaged, in cones, bowls, or cups. The ice cream is placed directly in the cones, bowl, or cup. With the present invention, ice cream remains on the cone, bowl, or cup with the use of candy floss (cotton candy), placed on the cone, bowl, or cup of various shapes and sizes. In this way, any melting ice cream avoid contact with the hands or clothes of the consumer.

In addition, the fact that candy floss is also a product that can be eaten increases the feeling of pleasure of eating the ice cream product.

### SUMMARY

An ice cream product arranged in such a manner that the ice cream stays on an ice cream cone, bowl, or cup even when the ice cream melts, which is particularly important when the ice cream product is being sold. A Candy floss is placed on an ice cream cone, bowl, cup, or other receptacle so as to completely cover and flow over the lateral parts of the ice cream cone, bowl, or cup. When the ice cream melts, the melted ice cream remains on the candy floss so as avoid contact with the consumer's hands and clothing, or any other area outside the cone, bowl, or cup.

### DRAWINGS

FIG. 1. Isometric Image of the Ice Cream Cone

FIG. 2. Isometric Image of the Bowl/Cup

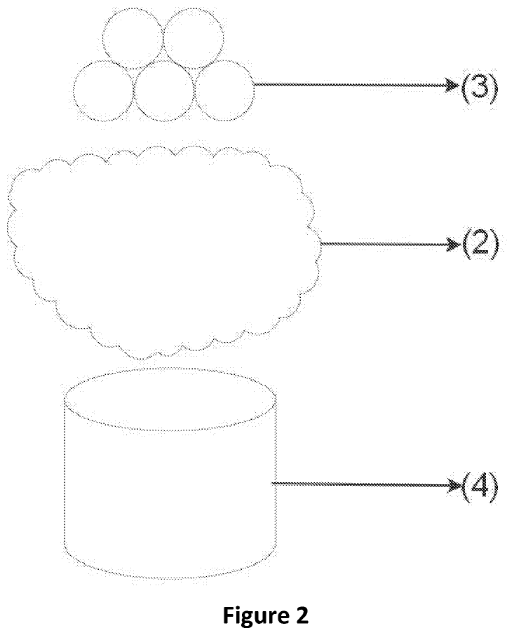

### DESCRIPTION

The Invention relates to an ice cream product designed to ensure that ice cream stays on an ice cream cone, bowl, or cup, even when the ice cream on the ice cream cone, bowl, or cup, melts when the product is offered for sale, packaged or unpackaged. The Invention consists of an ice cream cone (1), cotton candy (2), ice cream (3) and a bowl, cup, or receptacle (4).

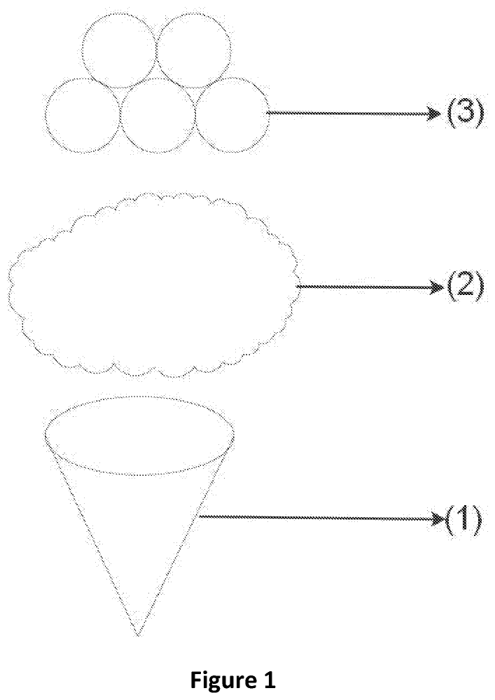

Ice cream cones (1) are produced in different structures using fine biscuits. Candy floss (“cotton candy”) (2), which is generally a colored candy, is produced by the use of sugar and additives. Candy floss (2) is named as such due to its structure which is as soft as floss. Candy floss (2) is placed on the ice cream cone (1) so as to completely cover and flow over lateral parts of the ice cream cone (1). Referring to FIG. 1, the ice cream cone (1), which is covered with candy floss (2), is served by the placement of the ice cream (3) in the middle of the candy floss (2). Depending on the weather conditions, in case of melting of the ice cream (3), the melted ice cream (3) remains on the candy floss (2).

Ice cream (3) can also be offered in the bowls or cups (4). The candy floss (2) is placed on the bowl or cup (4) so as to cover the entire bowl or cup (4) and flow over the lateral parts of the bowl or cup (4). It is served by adding ice cream (3) on the candy floss (2). Depending on the weather conditions, melting ice cream (3) remains on the candy floss (2) and therefore, does not contact consumers' clothes and outsides of the bowl or cup (4).

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed:

1- An ice cream product comprising candy floss (2), ice cream (3), and an ice cream cone (1), bowl, or cup (4).

2- The ice cream product of claim 1, wherein the candy floss (2) is disposed on the ice cream cone so as to completely cover the lateral parts of the ice cream cone, and the ice cream (3) is disposed in the middle of the candy floss (2).

3- The ice cream product of claim 1, wherein the candy floss (2) is disposed on the bowl or cup (4) so as to cover the entire interior of the bowl or cup (4) and flow over the lateral parts of the bowl or cup (4).
